(19) United States
(12) Patent Application Publication
(10) Pub. No.: US 2007/0185856 A1
(43) Pub. Date: Aug. 9, 2007

(54) System and method for managing attestations

(75) Inventors: Manish Mittal, Ghaziabad (IN); Puspendra Jaitly, New Delhi (IN); Ranbir Choudhary, Delhi (IN); Vinod Bahl, Greater Noida (IN)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc., New York, NY (US)

(21) Appl. No.: 11/337,083

(22) Filed: Jan. 23, 2006

(51) Int. Cl. G06F 17/30

(52) U.S. Cl. 707/5

(57) ABSTRACT

A system, method and computer program product to manage attestations. The attestations may be required for documents that include, for example, balance sheet accounts including financial information related to one or more business units of an organization. The system includes a database and one or more user interfaces. The database includes information related to one or more documents. The user interfaces are connected to the database and enable the users to interact with the database. The users may provide a positive or negative attestation corresponding to each document. Further, the users may add comments related to, for example, the positive or negative attestation. The attestations made by the users may be recorded in the database for future reference.

### BACKGROUND OF THE INVENTION

1. Field of the Invention

The present invention generally relates to electronic data management, and more particularly, to electronic exchange of financial information to establish compliance with regulatory or best practice standards.

2. Related Art

Compliance management is an integral part of the business strategy of any organization. With stricter regulatory norms, establishing compliance with regulatory or best practice standards is an emerging concern. Examples of regulatory or best practice standards includes the U.S. Sarbanes-Oxley Act of 2002 and the attendant rules of the U.S. Securities and Exchange Commission, which aim to improve the accuracy and reliability of corporate disclosures. According to the Sarbanes-Oxley standard, documents such as balance sheet accounts, which include information related to one or more business units of an organization, have to be attested by the authorities responsible for the business units. These attestations may be required, for example, before the public release of the information included in the documents. Examples of authorities attesting these documents may include account owners, who are responsible for the finances of the business units.

Existing solutions for managing attestations include electronically mailing the documents to the account owners. An information management team compiles the information related to the business units in the documents. The documents are then mailed to the corresponding account owners for attestation. The account owners attest the documents and mail the attested documents back to the information management team. In such existing solutions, a large number of emails have to be exchanged between the information management team and the account owners, primarily because of the number of documents that need to be attested. The number of account owners is also high, resulting in a large number of emails being exchanged during the process of attestation. Further, the documents have to be converted to different formats for different account owners. This requires the information management team to expend considerable effort in the procedure. Moreover, the account owners are dependent on the information management team for updates on the information related to the business units. The process of attestation in the existing solutions also takes a significant amount of time, and does not ensure the security of the information included in the documents.

Given the foregoing, what is needed is a system, method and computer program product for managing attestations of documents related to one or more business units of an organization, which enable electronic attestation of documents and reduce the number of emails being exchanged during the process of attestation.

### BRIEF SUMMARY OF THE INVENTION

The present invention meets the above-identified needs by providing a system, method and computer program product for managing attestations. An advantage of the present invention is that it enables management of electronic attestation of one or more documents. Another advantage of the present invention is that it does not require a large number of emails being exchanged during the process of attestation.

Yet another advantage of the present invention is that it provides a time-efficient and secured attestation process for managing the attestation of the documents. Still another advantage of the present invention is that it provides a regular update of the attestation process to the account owners responsible for attesting the documents.

Various embodiments of the present invention provide a system, method and computer program product for managing attestations of one or more documents related to one or more business units of an organization. The system includes a database and one or more user interfaces. The database includes information related to the documents in one or more predefined formats. The user interfaces are connected to the database and enable one or more users to interact with the database. The user interfaces may provide the users with an option to make a positive or negative attestation corresponding to each document. Further, the user interfaces may provide the users with an option to add comments related to, for example, the positive or negative attestation. The attestations made by the users may be recorded in the database for future reference.

Further features and advantages of the present invention, as well as the structure and operation of various embodiments of the present invention, are described in detail with reference to the accompanying drawings.

### BRIEF DESCRIPTION OF THE DRAWINGS/FIGURES

The features and advantages of the present invention will become more apparent from the detailed description set forth below, when taken in conjunction with the drawings, in which like reference numbers indicate identical or functionally similar elements. Additionally, the left-most digit of a reference number identifies the drawing in which the reference number first appears.

FIG. 1 is a system diagram of an exemplary system in which the present invention, in an embodiment, would be implemented.

FIG. 2 is a flowchart illustrating a process for managing attestations, according to an embodiment of the present invention.

FIGS. 3A and 3B illustrate a process for managing attestations, according to another embodiment of the present invention.

FIG. 4 is a block diagram of an exemplary computer system that is useful for implementing the present invention.

### DETAILED DESCRIPTION OF THE INVENTION

I. Overview

The present invention is directed to a system, method and computer program product for managing attestations. The attestations may be required for documents that include, for example, balance sheet accounts including financial information related to one or more business units of an organization. The attestations are typically provided by authorities who are responsible for the finances of the business units. The system described herein provides an efficient electronic attestation tool, which may be used to automate the process of attestation. In accordance with an embodiment of the present invention, the system may be used to establish compliance with, for example, the Sarbanes-Oxley standard.

The present invention is now described in more detail herein, in terms of the above exemplary system. This is for convenience only and is not intended to limit the application of the present invention. In fact, after reading the following description, it will be apparent to one skilled in the relevant art(s) how to implement the present invention in alternative embodiments.

The terms “user,” “account owner”, “process owner”, “authority” and/or the plural form of these terms, are used interchangeably, herein to refer to those persons or entities capable of accessing, using, being affected by, and/or benefiting from the tool that the present invention provides for managing attestations of documents.

II. System

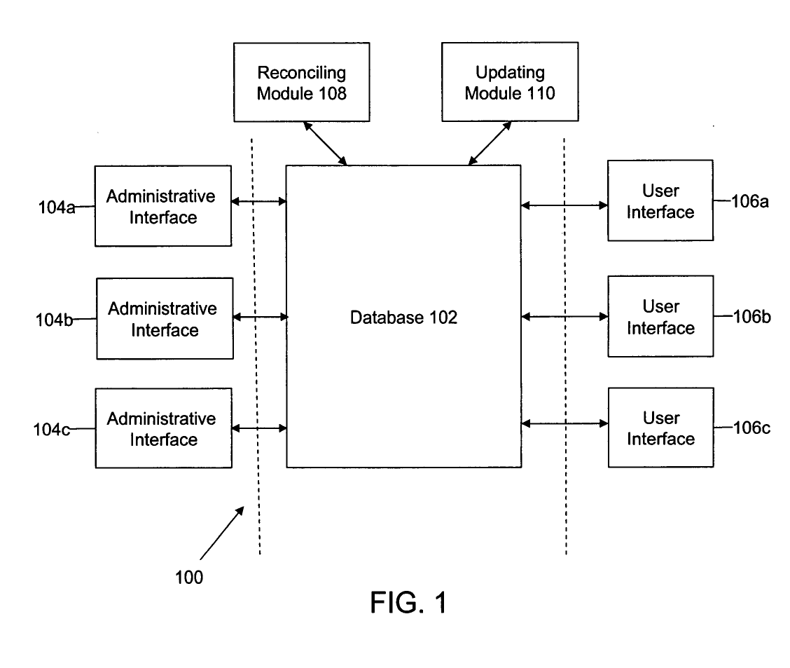

FIG. 1 is a system diagram of an exemplary system 100 for managing attestations in an embodiment of the present invention. System 100 may be used to manage attestations of one or more documents which may include, for example, financial information related to one or more business units of an organization. The attestations may be required, for example, to establish compliance with one or more regulatory or best practice standards, such as the Sarbanes Oxley standard, the Information Technology Infrastructure Library (ITIL) standard, or the like.

System 100 includes a database 102; one or more administrative interfaces 104 such as an administrative interface 104a, an administrative interface 104b, and an administrative interface 104c; and one or more user interfaces 106 such as a user interface 106a, a user interface 106b, and a user interface 106c. Database 102 includes information related to the documents. Herein, the documents may include, for example, balance sheet accounts that include financial information related to the business units of the organization.

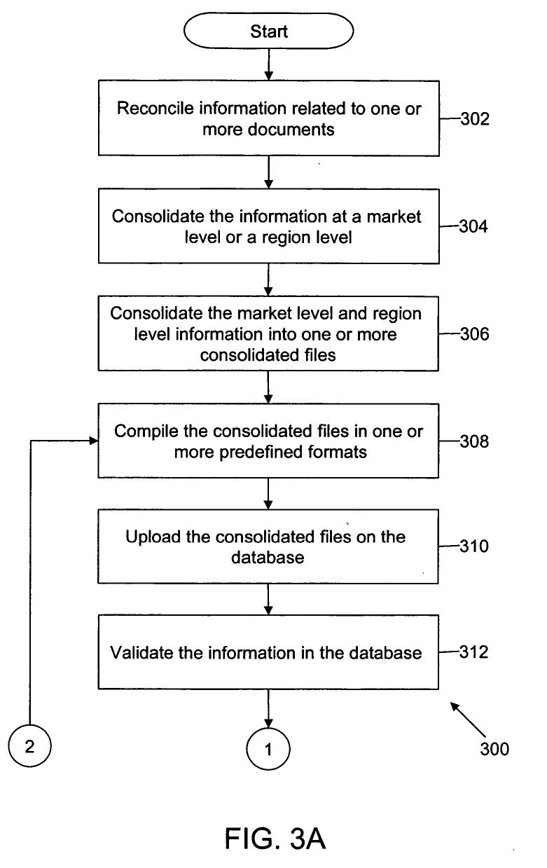

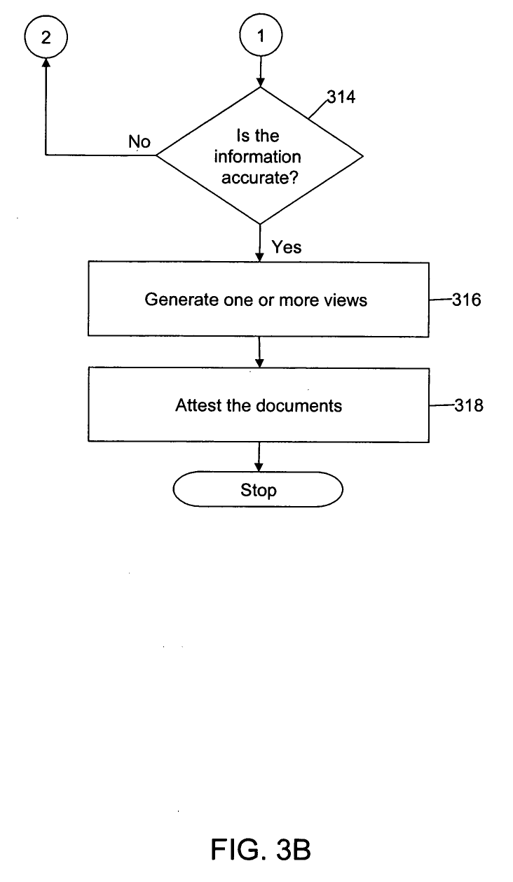

Database 102 may be managed by using administrative interfaces 104. Herein, managing may include, for example, creating or updating the information included in database 102. In accordance with an embodiment of the present invention, an information management team manages database 102 by using administrative interfaces 104. The process of creating and updating database 102 by using, for example, administrative interfaces 104 is described in detail below with reference to FIGS. 3A and 3B.

User interfaces 106 may be used by one or more users to view the information included in database 102. Further, the users may interact with database 102 and attest the documents by using user interfaces 106. Herein, the users may include authorities responsible for attesting the documents related to the business units of the organization. An example of the users may include account owners who are responsible for finances or processes related to the business units. Another example of the users may include process owners, who are less privileged users and may be authorized to view or attest only a portion of the documents related to the business units. In accordance with an embodiment of the present invention, a user-based authentication may be used to determine the access privileges provided to users such as account owners and process owners. Herein, the authentication may include, for example, entering a user-specific identification code.

In accordance with various embodiments of the present invention, a predefined user interface, such as user interface 106a, may be provided to each user, based on the identification codes. Further, the access privileges may be determined automatically or be predefined for each identification code.

In accordance with an embodiment of the present invention, each of user interfaces 106 includes options to allow a user to indicate a positive or a negative attestation corresponding to each document. Further, a user may provide comments regarding the attestation. In accordance with an embodiment of the present invention, user interfaces 106 may also include an option to extract the information related to the documents by, for example, downloading the information, printing the information, emailing the information, or the like.

In accordance with various embodiments of the present invention, the attestations performed by a user may be stored in database 102. The information management team may access the stored attestations by using administrative interfaces 104.

In accordance with an embodiment of the present invention, system 100 may further include a reconciling module 108 for reconciling the information related to the documents. Herein, the reconciliation may include, for example, checking whether the information is valid. Further, the reconciliation may include checking the accuracy and quality of the entire database 102. In accordance with another embodiment of the present invention, a data reconciliation team manually performs the reconciliation.

In accordance with an embodiment of the present invention, system 100 may also include an updating module 110 for updating the information included in database 102. Herein, the updating module may be used in conjunction with administrative interfaces 104, to update the information in database 102. The updating may be performed after a predefined time interval, for example, quarterly. In accordance with various embodiments of the present invention, the updating may be performed manually by, for example, the data reconciliation team.

In accordance with an embodiment of the present invention, database 102 includes one or more consolidated files that include information related to the documents. The consolidated files may be used to provide different information to different categories of users. The users may be categorized according to, for example, the business units managed by each user, the position of each user in the organization, the domain of expertise of each user, or the like. In accordance with an embodiment of the present invention, a consolidated file may be prepared for each user. The consolidated file may include information related to the documents, which may be attested by the corresponding user. In accordance with another embodiment of the present invention, a plurality of consolidated files may be prepared for each user, for example, to provide the information in different formats.

In accordance with various embodiments of the present invention, each document included in database 102 may be attested by at least one user, such as a process owner or an account owner. In accordance with an embodiment of the invention, a document may first be attested by a process owner and then by an account owner.

In accordance with an embodiment of the present invention, database 102 may include one or more user accounts. Each user account may be allocated to a user and may include information related to the documents, which may be attested by the user. The user may access the information included in a user account by, for example, providing an identification code. In accordance with another embodiment, one user account may be allocated to a set of users. In such a case, each user may have different access privileges. For example, a user may be able to view the information included in the user account, but may not be able to make attestations.

Database 102 may also include one or more access log files, each of which may include information relating to, for example, the users interacting with database 102. For example, the access log files may be, for example, Microsoft (MS) Excel files and may include Lotus Notes identification numbers for the users.

In accordance with an embodiment of the present invention, different user interfaces 106 may be provided for different users, for example, to provide the information according to the category of the user. For example, user interface 106a may be provided to a first user who is responsible for attesting a first set of documents, and user interface 106b may be provided to a second user who is responsible for attesting a second set of documents. The first set of documents may include the documents related to the business units for which the first user is responsible. The first user may be, for example, an account owner. Herein, user interface 106a may include a list of the first set of documents and may enable the first user to view and attest each of the first set of documents. The first user may attest a document by, for example, clicking on a button or an image on user interface 106a.

In accordance with an embodiment of the present invention, the second user may be a process owner, and the second set of documents may be a subset of the first set of documents. Herein, each document in the second set of documents may be attested by the second user. In accordance with another embodiment of the present invention, both the first user and the second user may attest the second set of documents, for example, in a predefined order.

In accordance with an embodiment of the present invention, the second set of documents may be identical to the first set of documents. In such a case, the second user may be able to view the information related to the second set of documents, but may not be allowed to attest all the documents in the second set of documents.

In accordance with yet another embodiment of the present invention, each of user interfaces 106 may include links to one or more web pages that may include, for example, one or more reports on the documents. The web pages may include, for example, a summary-level report, a market-level report, a detailed description, and the like. Further, each of user interfaces 106 may provide a user with the option to attest the documents.

In accordance with various embodiments of the present invention, system 100 may be implemented in a computational network. Herein, a computational network may include a system for exchanging data or transacting business such as the Internet, an Intranet, an Extranet, a Wide Area Network (WAN), a Local Area Network (LAN), a Virtual Private Network (VPN), satellite communication, or the like. Further, the computational network may be implemented as, for example, an Interactive Television (ITV) network. The computational network may include a plurality of interconnected computational devices such as computers, Personal Digital Assistants (PDAs), mobile phones, or the like. These computational devices may be running any operating system, for example, any version of Windows, MacOS, OS/2, BeOS, Linux, UNIX Solaris, or the like. Further, a user may interact with the computational devices by using an input device such as a keyboard, a mouse, a kiosk, a Personal Digital Assistant (PDA), a handheld computer, a cellular phone, or the like.

In accordance with an embodiment of the present invention, the computational network may be a secured computational network. The computational network may be secured by using a security model such as a zone-based security model, a session-based security model, or the like. In accordance with an embodiment of the present invention, the security model may be used for authenticating each user before the user may, for example, access at least one of user interfaces 106.

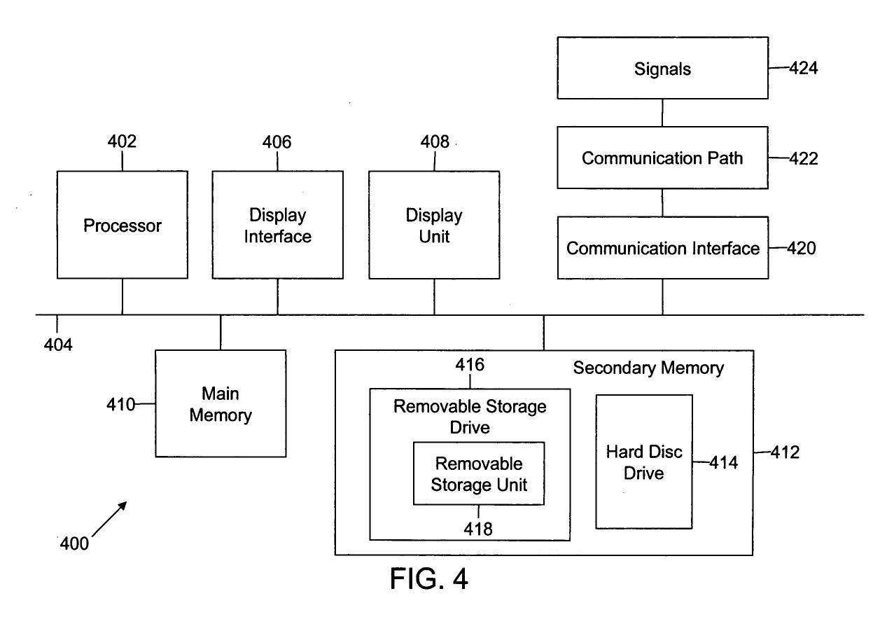

In accordance with an embodiment of the present invention, database 102 may be implemented in a host server. User interfaces 106 may be accessed by using one or more user systems, and administrative interfaces 104 may be accessed by using one or more administrative systems. The host server may be connected to the user systems and the administrative systems through a computational network. In accordance with various embodiments of the present invention, the host server, the user systems, and the administrative systems are similar in nature and type, and may include any of the aforementioned computational devices. Further, each of the host server, the user systems, and the administrative systems include at least a memory, a processor, and a display. In accordance with another embodiment of the present invention, the host server may be implemented in one of the administrative systems. The functionality of a system that is similar to the host server, the user systems, and the administrative systems is explained in detail below with reference to FIG. 4.

In accordance with various embodiments of the present invention, database 102 may be implemented using a web-based tool. In particular, database 102 is implemented by using Lotus Notes. In accordance with an embodiment of the present invention, database 102 may be implemented by using, for example, MS Access, Berkeley DB, Crystal Reports, FoxPro, Interbase, Microsoft SQL, Mysql, Oracle, Sybase, Btrieve, FileMaker, DB Reporting, or the like.

In accordance with various embodiments of the present invention, database 102 may include the information in one or more predefined formats such as an MS Excel format, an MS Access format, a Lotus 123 version 4 spreadsheet (WK4) format, or the like.

In accordance with an embodiment of the present invention, administrative interfaces 104 and user interfaces 106 may be, for example, graphical user interfaces, web-based user interfaces, command-line interfaces, or the like. Further, user interfaces 106 and administrative interfaces 104 may be implemented by using, for example, Hyper Text Markup Language (HTML) documents, java applets, javascripts, Active Server Pages (ASP), Common Gateway Interface (CGI) scripts, extensible markup language (XML), dynamic HTML, Cascading Style Sheets (CSS), plug-ins, or the like.

In accordance with an embodiment of the present invention, system 100 may be implemented in a compliance management system. Herein, the compliance management system may be used to establish compliance with one or more regulatory or best practice standards such as the Sarbanes-Oxley standard.

III. Process

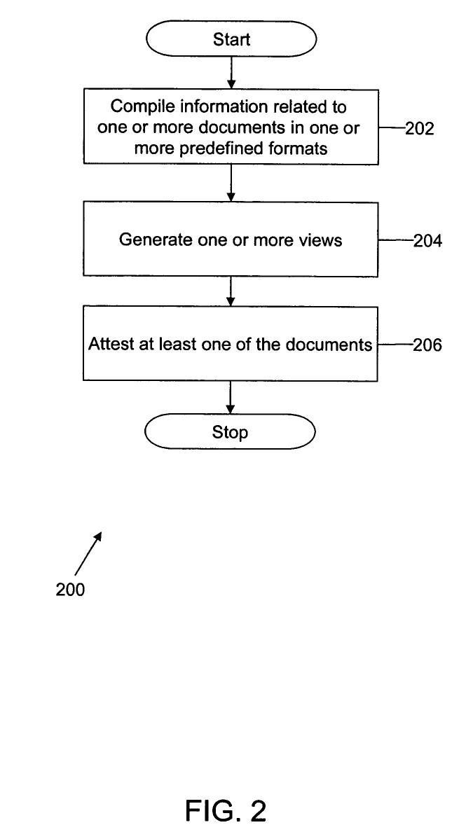

FIG. 2 shows a process 200 for managing attestations of one or more documents, according to one embodiment of the present invention. Process 200 begins at step 202, where information related to the documents is compiled in one or more predefined formats. The compiled information is stored in, for example, a database such as database 102. Examples of the predefined formats may include an MS Excel format, a WK4 format, an MS Access format, or the like. In accordance with an embodiment of the present invention, the predefined formats may be selected according to, for example, the number of users accessing the information, user interface requirements, the current infrastructure available to the users, or the like. In accordance with an embodiment of the present invention, the users may include individuals or groups responsible for attesting at least one document. The process of compiling the information is explained in detail below with reference to FIGS. 3A and 3B.

At step 204, one or more views of the information are generated for presentation to a user via interfaces 104 and/or 106 described above with reference to FIG. 1. The views may enable the users to interact with the compiled information stored in the database. The interaction may include, for example, viewing the compiled information, making attestations, or the like. Further, different views may be provided for different users according to the categories of users accessing the compiled information.

At step 206, at least one document is attested. Herein, the attestations may be provided by the users through the views. The attestations are recorded for future reference.

FIGS. 3A and 3B show a process 300 for managing attestations of one or more documents, according to an embodiment of the present invention. Process 300 begins at step 302, where information related to the documents is reconciled. The reconciliation may include, for example, an element-level check that involves checking whether each element in the information is valid. Further, the reconciliation may include checking the accuracy and quality of a database such as database 102. In accordance with an embodiment of the present invention, the reconciliation may be preformed manually by, for example, a data reconciliation team. In accordance with another embodiment of the present invention, the reconciliation may be performed automatically by using, for example, automation software. Herein, the information to be reconciled may be provided by one or more information providers. In accordance with an embodiment of the present invention, the information providers may include individuals or groups from different business units or branches of the same organization, situated, for example, at different geographical locations.

At step 304, a market-level or a region-level consolidation of the reconciled information is performed. The consolidation may be performed by, for example, individuals or groups responsible for the region or the market for which the consolidation is being performed. The consolidated market-level or region-level information is sent to an information management team. At step 306, the consolidated market-level or region-level information is consolidated for all the markets or regions by the information management team, and one or more consolidated files are generated. At step 308, the consolidated files are compiled in one or more predefined formats. In accordance with an embodiment of the present invention, the consolidated files may be compiled in an MS Excel format. Thereafter, the consolidated files may be converted to, for example, a WK4 format, an MS Access format, or the like.

At step 310, the consolidated files in the predefined formats are uploaded on a database such as database 102. In accordance with various embodiments of the present invention, step 310 may further include converting the consolidated files to a predefined database template prior to uploading the consolidated files on the database. The predefined database template may be designed according to, for example, the display required on a user interface such as user interface 106a. In accordance with an embodiment of the present invention, step 310 may also include deleting one or more files present in the database. The files may, for example, include documents for which the attestation process has been completed or out-of-date documents that have been superceded by newer versions. Step 310 may also include updating the files present on the database.

In accordance with an embodiment of the present invention, access log files may also be uploaded on the database according to the display required on the user interface in, for example, an MS Excel format, an MS Access format, or the like.

In accordance with various embodiments of the present invention, the uploading may be performed using, for example, administrative interfaces such as administrative interfaces 104. In accordance with an embodiment of the present invention, the information management team performs the uploading.

At step 312, the information included in the consolidated files uploaded on the database is validated. Herein, the validation may include, for example, comparing the information in the uploaded files with the reconciled information. In accordance with an embodiment of the present invention, the validation may be performed manually by, for example, the information management team. In accordance with another embodiment of the present invention, the validation may be performed electronically by using, for example, a software.

At step 314, a check is performed to determine whether the information in the consolidated files uploaded on the database is accurate. If the information is not accurate, then the method returns to step 308. If the information is accurate, then the method proceeds to step 316.

At step 316, one or more views of the information are generated. The views enable the users to interact with the database via user interface 106. Herein, the interaction may include, for example, viewing the information in the consolidated files, making attestations, or the like.

At step 318, the information included in the consolidated files is attested by the user(s). The user(s) may provide positive or negative attestations. In accordance with an embodiment of the present invention, the user(s) may also provide one or more comments related to, for example, the positive or negative attestations. Further, the user(s) may extract the information included in the consolidated files by, for example, downloading the information from the database, printing the information, emailing the information, or the like.

In accordance with an embodiment of the present invention, process 300 may also include a step for updating the information included in the database. In accordance with an embodiment of the present invention, the updating may be performed manually by, for example, the information management team. In accordance with another embodiment of the present invention, the updating may be performed automatically.

IV. Example Implementations

The present invention (i.e., [system 100, process 300] or any part(s) or function(s) thereof) may be implemented using hardware, software or a combination thereof and may be implemented in one or more computer systems or other processing systems. However, the manipulations performed by the present invention are referred to herein in terms, such as comparing or checking, which are commonly associated with mental operations performed by a human operator. No such capability of a human operator is necessary, or desirable in most cases, in any of the operations described herein which form a part of the present invention. Rather, the operations are machine operations. Useful machines for performing the operations in the present invention include general purpose digital computers or similar devices, such as computer system 400 of FIG. 4.

In fact, in accordance with an embodiment of the present invention, the present invention is directed toward one or more computer systems capable of carrying out the functionality described herein. An example of the computer systems includes computer system 400.

Computer system 400 includes one or more processors, such as a processor 402. Processor 402 is connected to a communication infrastructure 404, for example, a communications bus, a cross over bar, a network, or the like. Various software embodiments are described in terms of this exemplary computer system 400. After reading this description, it will become apparent to a person skilled in the relevant art(s) how to implement the present invention using other computer systems and/or architectures.

Computer system 400 includes a display interface 406 that forwards graphics, text, and other data from communication infrastructure 404 (or from a frame buffer which is not shown in FIG. 4) for display on a display unit 408.

Computer system 400 also includes a main memory 410, such as random access memory (RAM), and may also include a secondary memory 412. Secondary memory 412 may include, for example, a hard disk drive 414 and/or a removable storage drive 416, representing a floppy disk drive, a magnetic tape drive, an optical disk drive, etc. Removable storage drive 416 reads from and/or writes to a removable storage unit 418 in a well known manner. Removable storage unit 418 represents a floppy disk, magnetic tape, optical disk, or the like. Removable storage unit 418 may be read, and written to, by removable storage drive 416. As will be appreciated, removable storage unit 418 includes a computer usable storage medium having stored therein, computer software and/or data.

In accordance with various embodiments of the present invention, secondary memory 412 may include other similar devices for allowing computer programs or other instructions to be loaded into computer system 400. Such devices may include, for example, a removable storage unit such as removable storage unit 418, and an interface. Examples of such may include a program cartridge and cartridge interface (such as that found in video game devices), a removable memory chip (such as an erasable programmable read only memory (EPROM), flash memory, or programmable read only memory (PROM)) and associated socket, and other removable storage units and interfaces, which allow software and data to be transferred from removable storage unit 418 to computer system 400.

Computer system 400 may also include a communication interface 420. Communication interface 420 allows software and data to be transferred between computer system 400 and external devices. Examples of communication interface 420 may include a modem, a network interface (such as an Ethernet card), a communications port, a Personal Computer Memory Card International Association (PCMCIA) slot and card, or the like. Software and data transferred via communication interface 420 are in the form of a plurality of signals, hereinafter referred to as signals 424, which may be electronic, electromagnetic, optical or other signals capable of being received by communication interface 420. Signals 424 are provided to communication interface 420 via a communication path (e.g., channel) 422. Communication path 422 carries signals 424 and may be implemented using wire or cable, fiber optics, a telephone line, a cellular link, a radio frequency (RF) link and other communication channels.

In this document, the terms “computer program medium” and “computer usable medium” are used to generally refer to media such as removable storage drive 416, a hard disk installed in hard disk drive 414, signals 424, or the like. These computer program products provide software to computer system 400. The present invention includes such computer program products.

Computer programs (also referred to as computer control logic) are stored in main memory 410 and/or secondary memory 412. Computer programs may also be received via communication interface 420. Such computer programs, when executed, enable computer system 400 to perform the features of the present invention, as discussed herein. In particular, the computer programs, when executed, enable processor 402 to perform the features of the present invention. Accordingly, such computer programs represent controllers of computer system 400.

In accordance with an embodiment of the present invention, where the present invention is implemented using software, the software may be stored in a computer program product and loaded into computer system 400 using removable storage drive 416, hard disc drive 414 or communication interface 420. The control logic (software), when executed by processor 402, causes processor 402 to perform the functions of the present invention as described herein.

In another embodiment, the present invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the present invention is implemented using a combination of both the hardware and the software.

V. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A system for managing attestations, comprising:
(a) a database containing information related to one or more documents; and
(b) a user interface connected to the database to enable a user to interact with the database to attest at least one of the documents.

2. The system of claim 1, wherein the one or more documents comprise one or more balance sheet accounts including financial information related to a business unit.

3. The system of claim 1, further comprising an administrative interface connected to the database for managing the database.

4. The system of claim 1, further comprising a reconciling module to facilitate reconciliation of the information related to the one or more documents.

5. The system of claim 1, wherein the database is a Lotus Notes database.

6. A compliance management system utilizing the system of claim 1, the compliance management system managing compliance with one or more regulatory standards.

7. A method for managing attestations of one or more documents, comprising:
(a) compiling information related to the one or more documents in one or more predefined formats;
(b) generating a view to make the compiled information accessible to a user; and
(c) permitting the user, via the view, to attest to at least one of the documents.

8. The method of claim 7, further comprising the step of reconciling the information related to the one or more documents.

9. The method of claim 7, further comprising the step of validating the information related to the one or more documents.

10. The method of claim 7, further comprising the step of updating the information related to the one or more documents after a predefined time interval.

11. The method of claim 7, wherein the compiling step comprises:
compiling information related to the one or more documents in one or more predefined formats, wherein the at least one of the documents is a balance sheet account including financial information related to one or more business units.

12. The method of claim 7, further comprising the step of authenticating the user for attesting at least one of the one or more documents.

13. A computer program product comprising a computer usable medium having control logic stored therein for causing a computer to manage attestations of one or more documents, said control logic comprising:
first computer readable program code means for causing the computer to compile information related to the one or more documents in one or more predefined formats;
second computer readable program code means for causing the computer to generate a view making the compiled information accessible to a user; and
third computer readable program code means for causing the computer to record attestations of at least one of the one or more documents made by the user via the view.

14. The computer program product of claim 13, further comprising:
fourth computer readable program code means for causing the computer to reconcile the information related to the one or more documents.

15. The computer program product of claim 13, further comprising:
fourth computer readable program code means for causing the computer to validate the information related to the one or more documents.

16. The computer program product of claim 13, further comprising:
fourth computer readable program code means for causing the computer to update the information related to the one or more documents after a predefined time interval.
